(19) United States
(12) Patent Application Publication
(10) Pub. No.: US 2022/0252081 A1
(43) Pub. Date: Aug. 11, 2022

(54) FAN

(71) Applicant: CHAMP TECH OPTICAL (FOSHAN) CORPORATION, Foshan (CN)

(72) Inventors: XIAO-GUANG MA, Foshan (CN); YONG-KANG ZHANG, Foshan (CN); ZHENG LUO, Foshan (CN); YUNG-PING LIN, New Taipei (TW)

(21) Appl. No.: 17/502,295

(22) Filed: Oct. 15, 2021

(30) Foreign Application Priority Data
Feb. 5, 2021 (CN) 202110164695.7

(51) Int. Cl. F04D 29/38; F04D 29/66

(52) U.S. Cl. CPC F04D 29/386; F04D 29/388; F05D 2240/306; F05D 2240/305; F04D 29/667

(57) ABSTRACT

A fan includes a hub, a plurality of fan blades arranged around the hub and connected to the hub, and a plurality of guiding parts. Each of the plurality of fan blades comprises a windward surface and a leeward surface facing away from the windward surface. Each of the plurality of guiding parts is arranged on each of the plurality of fan blades. Each of the plurality of guiding parts comprises a plurality of guiding portions. Each of the plurality of the guiding portions protrudes from or is recessed in the windward surface or the leeward surface.

### FIELD

The subject matter herein generally relates to a fan.

### BACKGROUND

A traditional fan easily forms eddy currents during a rotating operation. The eddy currents will seriously interfere with the overall airflow, resulting in a decrease in the heat dissipating performance of the fan and an increase in noise.

Therefore, there is room for improvement within the art.

### BRIEF DESCRIPTION OF THE DRAWINGS

Implementations of the present technology will now be described, by way of example only, with reference to the attached figures.

FIG. 1 is a diagram of an embodiment of a fan.

FIG. 2 is a partially enlarged diagram of the fan at a position A of FIG. 1.

FIG. 3 is a partially enlarged diagram of another embodiment of a fan.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

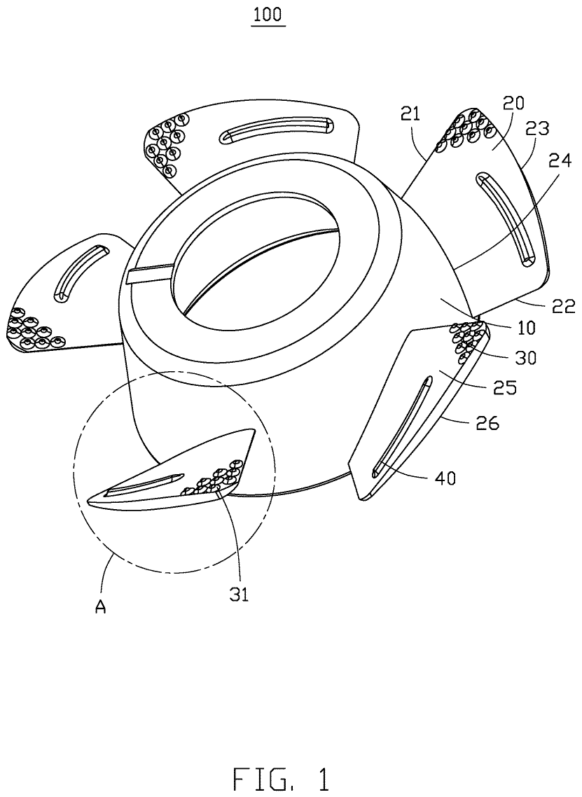

FIG. 1 illustrate an embodiment of a fan 100. The fan 100 include a hub 10, a plurality of fan blades 20 and a plurality of guiding parts 30. The plurality of fan blades 20 are arranged around the hub 10 and connected to the hub 10. Each of the plurality of guiding parts 30 is arranged on each of the plurality of fan blades 20. The hub 10 is used to connect to an external driving device and drives the plurality of fan blades 20 to rotate, so as to generate airflow by beating the air through the plurality of fan blades 20. The guiding part 30 on each of the plurality of fan blades 20 is used to increase a contact area between the fan 100 and the airflow, and absorb the airflow to flow out against a surface of each of the plurality of fan blades 20 when the fan 100 rotates. So that a flow field of the fan 100 is not easily peeled off, and eddy currents are prevented from forming, thereby improving a heat dissipation performance of the fan 100 and reducing a noise of the fan 100.

In at least one embodiment, the fan 100 includes five fan blades 20. Correspondingly, the number of the guiding parts 30 is five.

Referring to FIG. 1, each fan blade 20 includes a windward surface 21 and a leeward surface 22 facing away from the windward surface 21. The windward surface 21 faces a flow direction of the airflow generated by the corresponding fan blade 20, the leeward surface 22 faces away from the flow direction of the airflow generated by the corresponding fan blade 20. Each guiding part 30 includes a plurality of guiding portions 31. Each of the plurality of guiding portions 31 is connected to the windward surface 21 or the leeward surface 22. Each of the plurality of guiding portions 31 protrudes from either the corresponding windward surface 21 or the corresponding leeward surface 22, or is recessed in either the corresponding windward surface 21 or the corresponding leeward surface 22. The plurality of guiding portions 31 are used to increase the contact area between the fan 100 and the airflow, and absorb the airflow to flow out against the surface of each of the plurality of fan blades 20 when the fan 100 rotates. So that the flow field of the fan 100 is not easily peeled off, and eddy currents are prevented from forming, thereby improving the heat dissipation performance of the fan 100 and reducing the noise of the fan 100.

A shape of a cross section of each guiding portion 31 along a direction parallel to the corresponding windward surface 21 or the corresponding leeward surface 22 may be a circle, a triangle, or a polygon to adapt to the fan blades 10 with different shapes and sizes. In at least one embodiment, the shape of the cross section of each guiding portion 31 along the direction parallel to the corresponding windward surface 21 or the corresponding leeward surface 22 is a dodecagonal shape.

In at least one embodiment, some guiding portions 31 are arranged on the windward surface 21 and the leeward surface 22 of the fan blade 20. The guiding portions 31 on the windward surface 21 correspond to the guiding portions 31 on the leeward surface 22, so that the windward surface 21 and the leeward surface 22 of the fan blade 20 are uniformly stressed, thereby improving a stability of the fan blades 20. In at least one embodiment, the guiding portions 31 on the windward surface 21 protrude from the corresponding windward surface 21, and at the same time the guiding portions 31 on the leeward surface 22 protrude from the corresponding leeward surface 22. In at least one embodiment, the guiding portions 31 on the windward surface 21 are recessed in the corresponding windward surface 21, and at the same time the guiding portions 31 on the leeward surface 22 are recessed in the corresponding leeward surface 22.

In at least one embodiment, the windward surface 21 may be a convex surface, and the leeward surface 22 may be a concave surface, so as to increase the contact area between the fan blade 20 and the air, and effectively increase a flow rate of the airflow.

Referring to FIG. 1, each fan blade 20 includes a front edge 23, a rear edge 24, an outer edge 25, and an inner edge 26. The front edge 23 is an edge of the fan blade 20 that first contacts the air when the fan blade 20 rotates. The rear edge 24 is an edge facing opposite to the front edge 23. The outer edge 25 is connected to the front edge 23 and the rear edge 24, and is the farthest edge from the hub 10. The inner edge 26 is an edge where the fan blade 20 is connected to the hub 10.

In at least one embodiment, each guiding part 30 is arranged on the windward surface 21 of one of the fan blades 20. Each guiding part 30 includes nine guiding portions 31, of which three guiding portions 31 are arranged along the front edge 23 in sequence, the other three guiding portions 31 are arranged along the outer edge 25 in sequence. The guiding portions 31 along the front edge 23 and the guiding portions 31 along the outer edge 25 correspond to each other in pairs. A distance between the guiding portion 31 along the front edge 23 and the guiding portion 31 along the outer edge 25 corresponding to the guiding portion 31 along the front edge 23 increases as a distance away from a connecting corner of the front edge 23 and the outer edge 25 increases. The remaining three guiding portions 31 are arranged in a space between the guiding portions 31 along the front edge 23 and the guiding portions 31 along the outer edge 25. The nine guide portions 31 form a trapezoid-line shape.

Referring to FIG. 1, the fan 100 further include a plurality of guiding strips 40. Each of the guiding strips 40 are arranged on the windward surface 21 or the leeward surface 22. Each guiding strip 40 protrudes from or is recessed in the windward surface 21 or the leeward surface 22 to divide the airflow into several parts, so as to reduce a resistance of the airflow and increase a flow rate of the airflow.

When a plurality of the guiding strips 40 are arranged on the windward surface 21 and the leeward surface 22, the guiding strips 40 on the windward surface 21 correspond to the guiding strips 40 on the leeward surface 22, so that the windward surface 21 and the leeward surface 22 of the fan blade 20 are uniformly stressed, thereby improving a stability of the fan blades 20. In at least one embodiment, the guiding strips 40 on the windward surface 21 protrude from the corresponding windward surface 21, and at the same time the guiding strips 40 on the leeward surface 22 protrude from the corresponding leeward surface 22. In at least one embodiment, the guiding strips 40 on the windward surface 21 are recessed in the corresponding windward surface 21, and at the same time the guiding strips 40 on the leeward surface 22 are recessed in the corresponding leeward surface 22.

In at least one embodiment, one guiding strip 40 is arranged on the windward surface 21 of one fan blade 20. The guiding strip 40 extends from a side of the guiding part 30 o a connecting corner of the rear edge 24 and the outer edge 25. The guiding strip 40 extends along an arc. The guiding strip 40 guides the air flow from the front edge 23 of the fan blade 20 to the rear edge 24 of the fan blade 20 to reduce the resistance of the airflow and increase the flow rate of the airflow.

Referring to FIG. 1, each fan blade 20 is obliquely arranged on a peripheral surface of the hub 10, and both the inner edge 26 and the outer edge 25 of the fan blade 20 are arc-shaped. So that a contact area between each fan blade 20 and the air is increased and the flow rate of the airflow is effectively increased when the fan blades 20 rotate.

In at least one embodiment, a distance between the front edge 23 and rear edge 24 gradually increases along a direction from the inner edge 26 to the outer edge 25, so that an area of a portion of each fan blade 20 close to the outer edge 25 is greater than an area of a portion of the fan blade 20 close to the inner edge 26, thereby increasing the low rate of the airflow. The connecting corner of the front edge 23 and the outer edge 25 and the connecting corner of the rear edge 24 and the outer edge 25 are all arc-shaped, thereby accelerating the flow rate of the airflow and improving the heat dissipation performance of the fan 100.

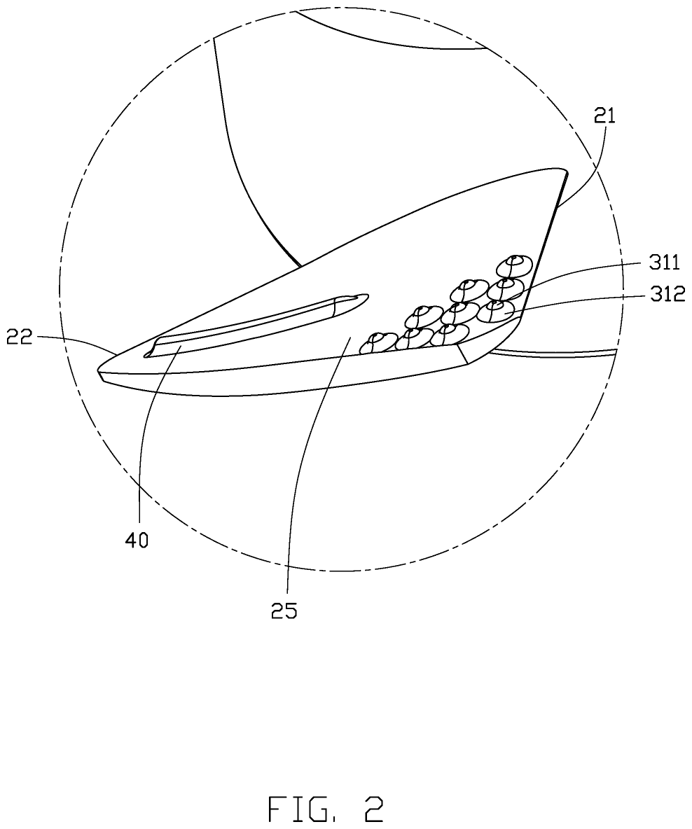

Referring to FIG. 2, each guiding portion 31 protrudes from the windward surface 21 of each fan blade 20, and a cross section of each guiding portion 31 parallel to the windward surface 21 or the leeward surface 22 has a circular shape. Specifically, an end surface of each guiding portion 31 facing away from the windward surface 21 is a first arc-shaped surface 311, and the first arc-shaped surface 311 and the surface of the fan blade 20 are connected by a smooth transition surface 312. The contact area between each fan blade 20 and the airflow is increased by the first arc-shaped surface 311 and the transition surface 312, so as to absorb the airflow flowing out against the surface of each of the plurality of fan blades 20 when the fan 100 rotates. So that the flow field of the fan 100 is not easily peeled off, and eddy currents are prevented from forming, thereby improving the heat dissipation performance of the fan 100 and reducing the noise of the fan 100.

In at least one embodiment, the first arc-shaped surface 311 is a hemispherical surface, and the transition surface 312 is an arc-shaped surface recessed inside the guiding portion 31.

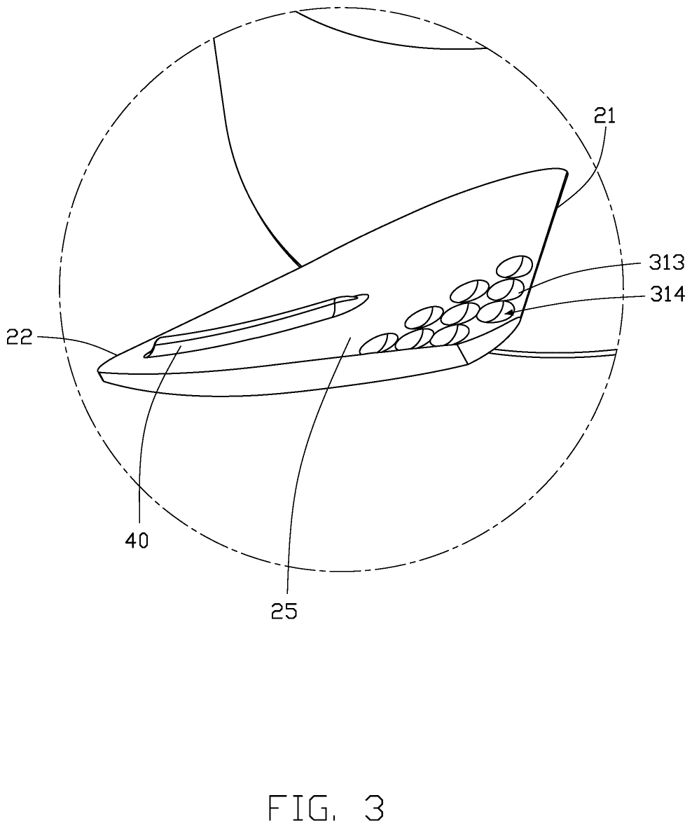

Referring to FIG. 3, in at least one embodiment, each guiding portion 31 is recessed in the windward surface 21, and a cross section of each guiding portion 31 parallel to the windward surface 21 or the leeward surface 22 has a circular shape. Specifically, each guiding portion 31 includes a circular opening 313 on the windward surface 21, and each guiding portion 31 includes a cavity 314 communicating with the circular opening 313 in the fan blade 20. An inner surface defining the cavity 314 is a smooth arc surface. When the fan blade 20 rotates, the airflow flows into the cavity 314 from the circular opening 313, the contact area between each fan blade 20 and the airflow is increased by the first arc-shaped surface 311 and the transition surface 312, so as to absorb the airflow flowing out against the surface of each of the plurality of fan blades 20 when the fan 100 rotates. So that the flow field of the fan 100 is not easily peeled off, and eddy currents are prevented from forming, thereby improving the heat dissipation performance of the fan 100 and reducing the noise of the fan 100.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A fan comprising:
a hub;
a plurality of fan blades arranged around the hub and connected to the hub; and
a plurality of guiding parts;
wherein each of the plurality of fan blades comprises a windward surface and a leeward surface facing away from the windward surface, each of the plurality of guiding parts is arranged on each of the plurality of fan blades, each of the plurality of guiding parts comprises a plurality of guiding portions, each of the plurality of the guiding portions protrudes from or is recessed in the windward surface or the leeward surface.

2. The fan of claim 1, wherein a shape of a cross section of the each of the plurality of guiding portions on the windward surface or the leeward surface parallel to the corresponding windward surface or the corresponding leeward surface is circle.

3. The fan of claim 1, wherein a shape of a cross section of each of the plurality of guiding portions on the windward surface or the leeward surface parallel to the corresponding windward surface or the corresponding leeward surface is a triangle or a polygon.

4. The fan of claim 1, wherein the plurality of the guiding portions are distributed on the windward surface and the leeward surface of a same fan blade, each guiding portion on the windward surface corresponds to one guiding portion on the leeward surface.

5. The fan of claim 1, wherein the fan further comprises a plurality of guiding strips, each of the plurality of guiding strips protrudes from or is recessed in the windward surface or the leeward surface.

6. The fan of claim 5, wherein the plurality of the guiding strips are distributed on the windward surface and the leeward surface of a same fan blade, each guiding strip on the windward surface corresponds to one guiding strip on the leeward surface.

7. The fan of claim 6, wherein each guiding strip on the windward surface protrudes from the corresponding windward surface, and each guiding strip on the leeward surface protrudes from the corresponding leeward surface.

8. The fan of claim 6, wherein each guiding strip on the windward surface is recessed in the corresponding windward surface, and each guiding strip on the leeward surface is recessed in the corresponding leeward surface.

9. The fan of claim 1, wherein each of the plurality of fan blades comprises a front edge, a rear edge, an outer edge, and an inner edge, the front edge is an edge of each of the plurality of fan blades that first contacts the air when the fan rotates, the rear edge is an edge of each of the plurality of fan blades facing away from the front edge, the outer edge is connected to the front edge and the rear edge and is the farthest edge of each of the plurality of fan blades from the hub, and the inner edge is an edge where each of the plurality of fan blades is connected to the hub.

10. The fan of claim 9, wherein a distance between the front edge and rear edge increases along a direction from the inner edge to the outer edge.

11. The fan of claim 9, wherein each of the plurality of fan blades is obliquely arranged on a peripheral surface of the hub, and the inner edge and the outer edge of the each of the plurality of fan blades are both arc-shaped.

12. The fan of claim 9, wherein a connecting corner of the front edge and the outer edge and a connecting corner of the rear edge and the outer edge are both arc-shaped.
